(19) United States
(12) Patent Application Publication
(10) Pub. No.: US 2009/0288563 A1
(43) Pub. Date: Nov. 26, 2009

(54) Toaster-and-Oven Device

(76) Inventor: Jaesang Lim, GeumJeong-Gu (KR)

Correspondence Address: THE LAW OFFICE OF EDWARD L BISHOP, 1240 S. OLD FORGE CT., PALATINE, IL, 60067, US

(21) Appl. No.: 12/425,945

(22) Filed: Apr. 17, 2009

(30) Foreign Application Priority Data
Apr. 17, 2008 (KR) 10-2008-0035446

(51) Int. Cl. A47J 37/08

(52) U.S. Cl. 99/326; 99/400

(57) ABSTRACT

A toaster-and-oven device with visible interior, wherein bread or cooking ingredients are added and removed through the side, and wherein the bread can be gripped while toasting. The toaster of the present invention comprises: a housing located above the base and furnished with an internal dome wherein an internal space is formed; multiple toast holders that hold pieces of bread at a distance from one another, placed at specified intervals on the interior of the said internal dome and actually positioned in a vertical or horizontal direction with respect to the said base, on the surface whereof are furnished transparent surface heating elements; a door furnished with a door frame that connects to the interior of the said housing and wherein the lower edge is connected to the said housing by hinges so as to open and close at one side of the said internal dome and housing; and toast holders furnished on the said base and formed so as to contract so that if the said door is closed, the bread can be gripped between the aforementioned toast holders. The door swings left to right, and while the door is closed, the door is kept locked by the mechanical locking device (FIG. 6a); when electrified, it opens automatically in response to electric circuit signals or the operation of a solenoid or magnet, and is configured (FIGS. 6a, 6b, 6c) with a structure whereby the door can be automatically or manually opened at any time; it also includes a structure wherein if the door closes the sensor determines whether or not to toast based on whether or not electric heat is detected.

### CROSS REFERENCE TO RELATED APPLICATION

This application claims priority to Korean Patent Application No. 10-2008-0035446, filed on Apr. 17, 2008, and incorporated herein by reference.

### TECHNICAL FIELD

The present invention concerns a toaster and oven device, and more specifically a toaster wherein bread can be inserted and removed through the side, and the toasting status of the bread can be verified visually while it is toasting, and wherein transparent surface heating elements are used that toast the bread evenly and rapidly heat to a temperature of 280° C. or greater within 1-2 minutes, and wherein the interior is transparently visible and there is sensor functionality that determines whether or not to heat based on the presence or absence of bread and that can maintain the optimal temperature for toasting, and wherein there is functionality for opening and closing the door automatically, and wherein when the heating elements are electrified, no toasting whatsoever occurs until the LED has been actuated that indicates whether heating is taking place.

### BACKGROUND OF THE INVENTION

A toaster is a device that typically toasts the surface of bread by electric heating of bread that has been cut to a specific thickness.

These toasters typically use electric heating wires, and often use a pop-up method such that bread is placed between heating elements set at a distance apart and then toasted for a specified time, and when the bread has been toasted, the pieces are popped up on each side.

However, a toaster such as described above has the disadvantage that heat is lost through the access points on either side of the toaster while the bread is being toasted.

Because the access point at which bread is inserted is open, heat emitted by the heating element is lost through the said access point. Due to this, there is the problem that more energy than necessary is consumed in toasting the bread, and the bread is not toasted evenly, and if the bread is not removed at the right time, the portion held within the toaster is burnt black by the latent heat; further, due to the high heat loss, the toasting time is increased.

In addition, while the bread is toasting in the interior, the toasted bread is not toasted evenly and excessive time is taken due to the high heat loss; in addition, in the pop-up method, after the toaster has completed toasting, there have been occasions when the bread is popped up too high and falls to the ground.

Accordingly, inasmuch as the interior of the toaster is not observable, the degree of toasting cannot be confirmed visually while the bread is being toasted, and because only the degree of toasting of a portion of the bread can be confirmed through the access hole, it has been quite common for it to be burned black. In addition, because heating wires and mica plates are used, it is very problematic to adjust the bread-toasting temperature using a temperature sensor, and if the bread holder is not electrified, it does not grip.

In addition, hygiene problems arising from the use of primarily mica plates for the heating plates, such as covering with mica powder after long-term use, cannot be ignored, and although there have been surface heating elements, they are opaque such as carbon elements and in some cases are limited to a temperature increase of 120° C.-250° C.; further, it may take as much as 5-10 minutes to reach this temperature, which is unsuitable for cooking equipment.

### SUMMARY OF THE INVENTION

The objective of the present invention, which has been devised in order to resolve problems such as those described above, is to provide a toaster that opens on the side, that can hold the bread cooking status while the bread is being toasted, that enables observation of the interior from outside, that prevents loss of heat while toasting bread evenly and rapidly, that is clean due to the use of transparent surface heating elements, that can easily be cleaned and poses no risk of mica powder etc., and that facilitates temperature adjustment.

In order to attain the above-described objective, the toaster of the present invention comprises: a housing located on top of the base and furnished with an internal dome with a space formed internally; multiple support plates positioned at intervals in the interior of the said internal dome and actually oriented either vertically or horizontally with respect to the said base, and furnished on the surface with transparent surface heating elements; a door the bottom edge whereof is hinged to the said housing so that one side of the said internal dome and housing can be opened and closed, and furnished with a door frame that extends into the interior of the said housing; and toast holders furnished on the said door, and formed so as to contract in a way that enables gripping of the bread between the said support plates when the said door is closed.

On the bottom of the said support plates, a guide is formed that protrudes toward the facing support plate, and the said toast holder comprises a pair of holder frames that are positioned at a set interval and in contact with the bread surface and that extend from the said door toward the interior; connecting members that hinge the respective holder frames at the back of the said pair of holder frames; and elastic members that provide elastic support that enables the front ends of the said pair of holder frames to spread apart from each other, wherein both ends are connected respectively to the back of the said pair of holder frames; when the said door is closed, the front end of the said holder frame contacts the said guide and the holder frame contracts so as to grip the bread.

It is preferable that the said housing, internal dome and support plates be of a transparent material.

Likewise, it is preferable that the said heating elements be transparent surface heating elements and that these transparent surface heating elements be sealed.

In addition, on the said base a slanted area is formed on the outside, and a door-locking means is furnished comprising a push-load furnished so as to slide on the said base, a solenoid that advances the said push-load when the slanted portion is pushed, due to the front adjoining the said slanted portion; and a locking block that is in contact with the front of the said push-load and can slide on the said door-frame and that provides elastic support while optionally locking to the said base; the said door is connected by springs so as to provide elastic support to the said base, and if the binding of the locking block at the said door locking means is released from the base, the door is opened.

In addition, a bread-sensing means that confirms the presence or absence of bread can also be furnished on the said support plates.

The said bread-sensing means is furnished on the light-emitting unit of the farthest-outside support plate and the support plate positioned on the furthest-external position opposite the said support plate, and preferably includes a light-receiving unit that outputs a signal upon receiving the light emitted by the said light-emitting unit.

In addition, any one or more of the said base, support plates or internal dome can be furnished with light(s) to illuminate the internal dome.

It is preferable that there additionally be furnished a wedge on the bottom of the said door frame, and door-closure sensing means that sense the closure or opening of the door, and are placed at intervals on the base and that include multiple electroconductive plates that come into contact with the said wedge upon closure of the said door.

In addition, on the said support plate a heat sensor is also furnished, and if the said heat sensor detects that the temperature of the said bread has exceeded the specified temperature, the heating by the said heat elements is cut off, and additional system circuits and devices are added so as to adjust the current internal temperature and bread-toasting time based on the non-conformity of the internal toaster temperature at the first operation and upon multiple repeated operations.

Accordingly, in order to collect breadcrumbs, a sliding-capable tray is also furnished on the said base.

According to the above-described toaster of the present invention, the warping of toasted bread can be prevented by gripping of both sides of the bread by the bread holders while the bread is being toasted.

In addition, because heat generated by the heating elements does not leak out, the loss of energy consumed in toasting bread can be prevented, and therefore the bread toasts quickly; due to the transparent surface heating method, it is neat and easy to clean, toasts evenly and correctly (because of the adjustable temperature), and has great hygienic effects such as preventing covering with mica powder.

Accordingly, because the interior of the toaster can be observed, it is possible easily to observe the degree to which the bread has toasted while toasting, so that it can be toasted to the desired degree (color), without any overtoasting or undertoasting.

### BRIEF DESCRIPTION OF THE DRAWINGS

To understand the present invention, it will now be described by way of example, with reference to the accompanying drawings in which:

FIG. 1 is a front sectional view of the toaster of the present invention.

FIG. 2 is a diagram depicting the state of FIG. 1 wherein the door is open.

FIG. 3 is a side cross-section of the toaster of the present invention.

FIGS. 4a and 4b are plans of the operation of the toast holders of the toaster of the present invention.

FIG. 5 is a side cross-section showing the operations of the toast holders of the toaster of the present invention.

FIGS. 6a through 6c are expanded front sectional views showing the operation of the door locking means of the toaster of the present invention.

### EXPLANATION OF PRINCIPAL ELEMENTS OF THE DIAGRAMS

| | |
|---|---|
| 1: Toaster | 2: Bread |
| 11: Base | 11a: Stopping end |
| 12: Housing | 13: Internal dome |
| 21: Support plate | 22: Heating element |
| 23: Guide | 31: Door |
| 32: Door frame | 32a: Outlet hole |
| 33: Torsion spring | 34: Tray |
| 40: Toast holder | 41: Holder frame |
| 42: Connecting member | 43: Elastic member |
| 50: Door locking means | 51: Push load |
| 51a: Tilted area | 52: Solenoid |
| 53: Locking block | 53a: Stopping side |
| 53b: Tilted side | 54: Door opening/closing detection means |
| 54a: Wedge | 54b: Electroconductive plate |
| 61: Light-emitting unit | 62: Light-receiving unit |
| 63: Temperature sensor | 64: Light |
| 71: Adjusting switch | 80: Air vent for cooling |
| 81: Eyelet | |

### DETAILED DESCRIPTION OF THE INVENTION

While this invention is susceptible of embodiments in many different forms, there are shown in the drawings and will herein be described in detail preferred embodiments of the invention with the understanding that the present disclosure is to be considered as an exemplification of the principles of the invention and is not intended to limit the broad aspects of the invention to the embodiments illustrated.

Hereinbelow, a preferred embodiment of a toaster based on an embodiment of the present invention will be described, with reference to the attached drawings.

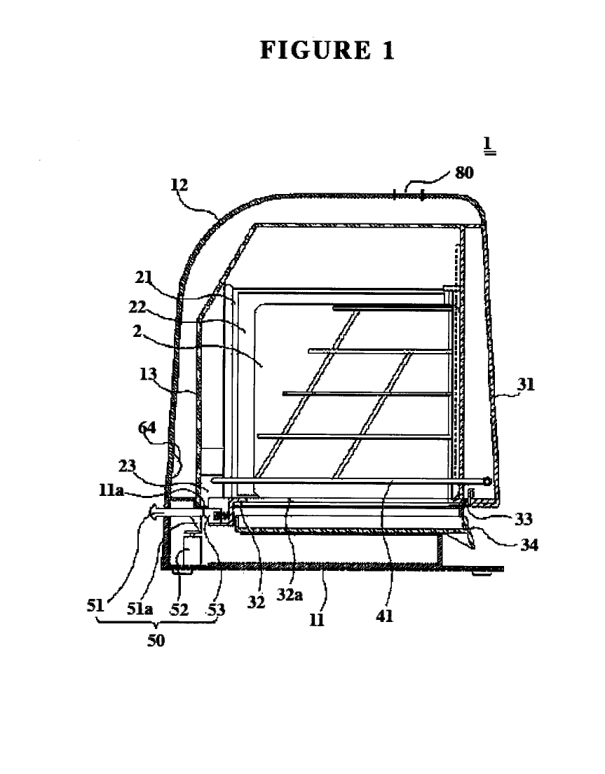

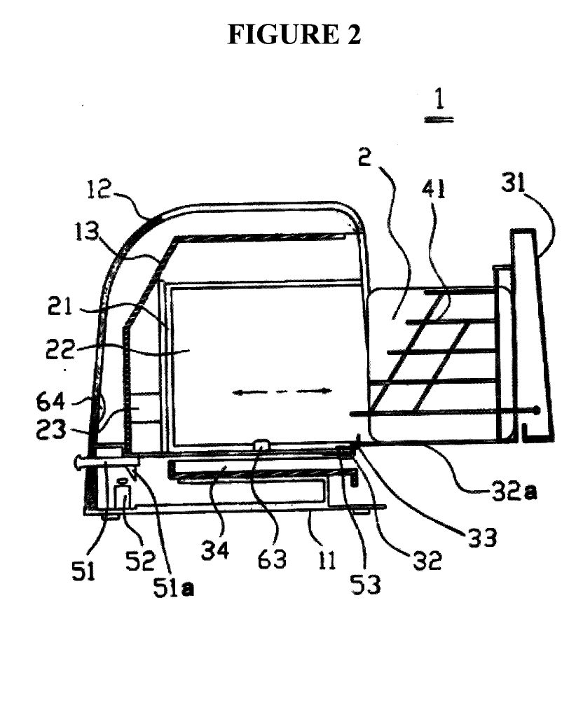

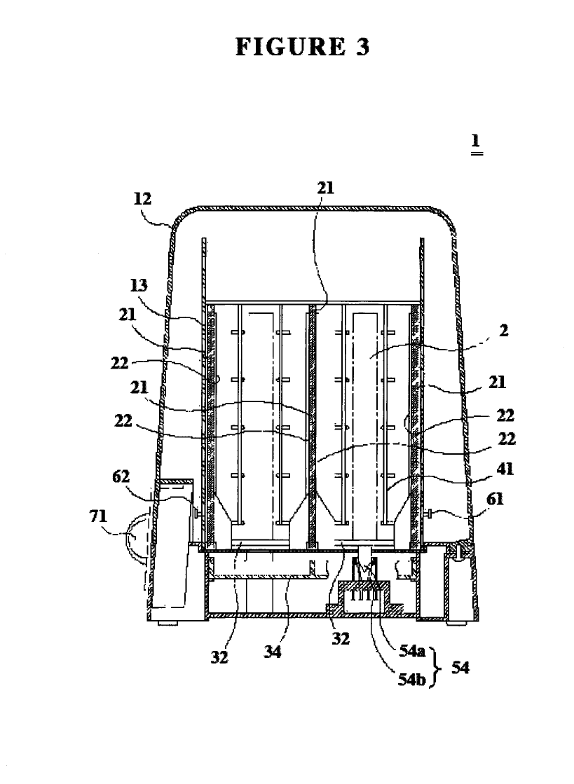

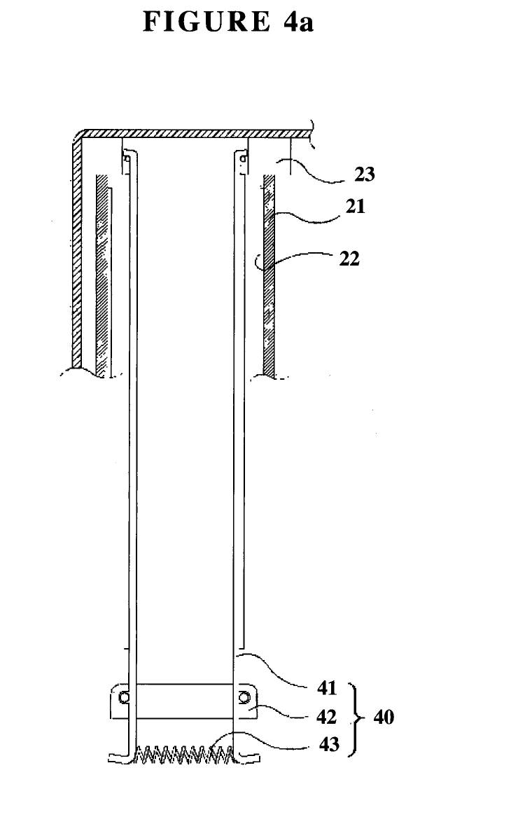

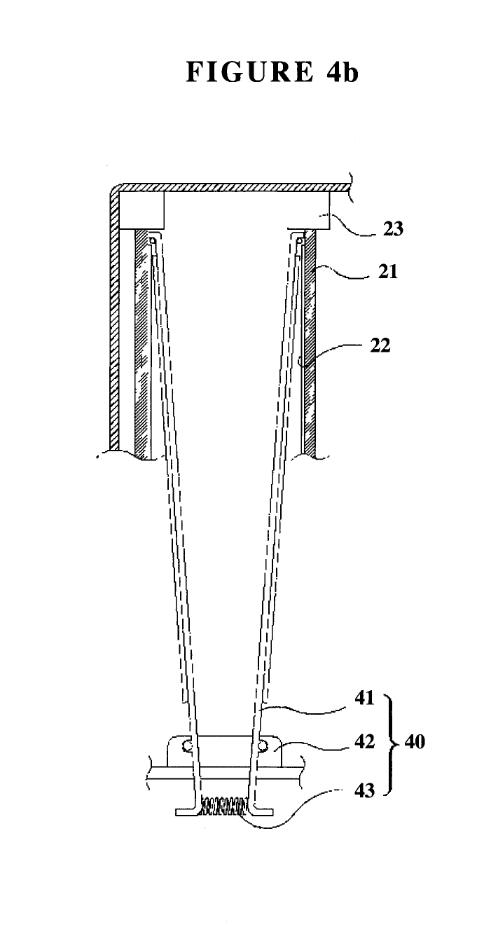

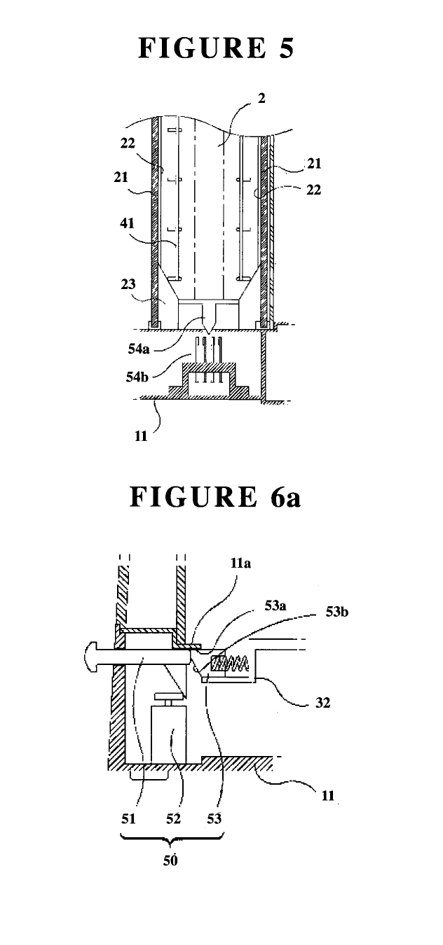

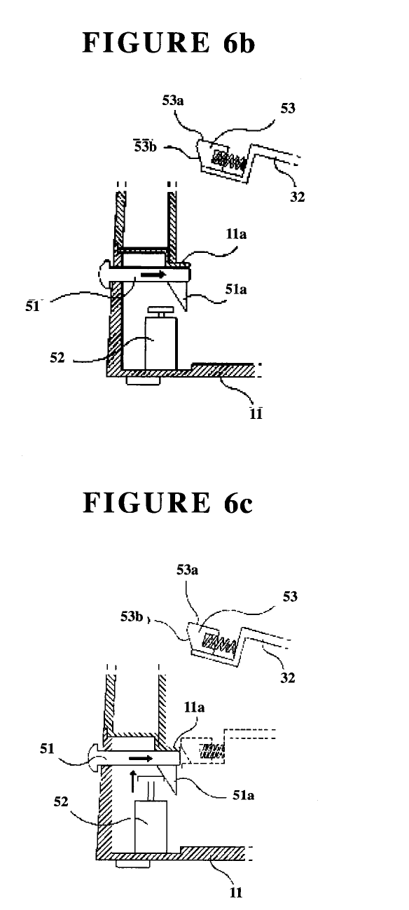

FIG. 1 is a front sectional view of a toaster according to the present invention; FIG. 2 depicts FIG. 1 with the door opened; FIG. 3 is a side cross section of the toaster of FIG. 1; FIGS. 4a and 4b are plans showing the operating state of the toast holders of the toaster of the present invention; FIG. 5 is a side cross-section showing the operating state of the toast holder of the toaster of the present invention; and FIGS. 6a through 6c are expanded front sectional views showing the operation of the door locking means of the toaster of the present invention.

The toaster of the present invention, as depicted in FIGS. 1 and 2, comprises: a housing (12) that forms the exterior of the toaster (1) such as to form an internal space; support plates (21) that are placed at specific intervals in the interior of the said housing (12) so that bread (2) is place between them, and that are furnished on the surface with surface heating elements (22); a door (31) that is hinged to one side of the said housing (12) opens and closes one side of the said housing (12); and a toast holder (40) that is furnished on the said door (31) and that grips the bread (2) to hold it straight while the bread (2) is toasting between the said support plates (21).

The housing (12) is furnished on a base (11) and forms the exterior of the toaster (1); an interior dome (13) is furnished that forms an internal space wherein the bread is toasted.

The support plates (21) are furnished on the interior of the said internal dome (13) so as to be positioned at specified intervals either vertically or horizontally with respect to the said base (11), and heating elements (22) are furnished on the surface of the said support plates (21). To expand on this description, the support plates (21) and surface heating elements (22) are integrated into a single unit, i.e., a heat-resistant glass plate is painted with transparent heat elements and electric poles are formed, appearing as a transparent glass plate.

The bread (2) is placed between the support plates (21) that are positioned at specific intervals, and toasted. For instance, in the case of a toaster (1) that can toast 2 pieces of bread, 3 support plates (21) are placed at intervals and can toast 2 slices of bread (see FIG. 3).

Heating elements (22) are furnished on the surface of the said support plates (21) so as to toast the bread. The said heating elements (22) can be installed at low thickness in a narrow space, and should preferably be surface heating elements that can apply heat evenly to the surface of the bread. The surface heating elements form a heating structure by ion-coating or painting of the transparent heating element onto the transparent heat-resistant glass plate, and poles are then affixed to each end to create a transparent surface heating element. Thus, the support plates are united with the transparent surface heating elements. Thus, due to surface-heating, the bread can be heated evenly and toasted quickly.

Here, it is preferable that the housing (12), internal dome (13) and support plates (21) be formed of transparent material. The housing (12), internal dome (13) and support plates (21) are formed of transparent material so that the progress of bread toasting can be seen by observing the interior of the toaster (I) from outside. In particular, the internal dome (13) and support plates (21) that directly contact or adjoin the heating elements (22) can be fabricated using heat-resistant tempered glass, and the housing (12) can be fabricated from plastic. In such case, in order to prevent overheating of the housing (12), a vent hole for cooling (80) can be installed in the top of the housing and an eyelet (81) devised there

In addition, it is preferable that observation from outside be facilitated by also making the heating elements (22) be transparent surface heating elements. By furnishing heating elements (22) of transparent material, just as with the said housing (12), internal dome (13) and support plate (21), the interior of the toaster (1) can be observed from outside. The transparent surface heating elements here are surface heating elements, a type of semiconductor-type heating elements formed by painting or ion-coating a liquid coating solution onto the surface of a heat-resistant glass or ceramic plate so as to form a surface membrane transparent to most wavelengths of visible light, and connecting the electric poles to each terminal of the surface membrane so that when electric power is supplied, the said surface membrane generates heat.

Here, the said transparent surface heating elements must have a heating temperature of at least 280° C., and must take at least, but no more than, 1-2 minutes to rise to that temperature.

The door (31) is furnished on one side of the said housing (12) and internal dome (13), and is used to insert and remove bread from the interior of the toaster (1). The door (31) is designed to open and close horizontally and is hinged to the housing (12) or internal dome (13), so that the bread can be inserted and removed. The bottom of the door (31) is hinged to the said housing (12) or the bottom of the internal dome (13), so that the top part of the said door (31) opens and closes horizontally, around the bottom edge.

In addition, the bottom of the door (31) is formed to extend the door frame (32) toward the interior of the said internal dome (13). The said door frame (32) supports the bottom of the bread; the bread is located inside the support plates (21), and an outlet hole (32a) is formed so that crumbs can fall down from the bread.

In addition, by furnishing a tray (34) that can slide into the housing (12) below the said outlet hole (32a), it is made possible for the crumbs falling through the said outlet hole (32a) to collect on a tray (34).

The toast holders (40), as shown in FIGS. 4a and 4b, are furnished on the said door (31), and designed to grip the bread within the said support plates (21). The toast holders (40) comprise a pair of holder frames (41) positioned at a specified interval, a connecting member (42) hinged to both of the said pair of holder frames (41) and located behind the said holder frames (41); and an elastic member (43) connected to the back of the said holder frame (41) so as to spread open the said holder frames (41).

The holder frames (41) are furnished in pairs, and positioned at a specified interval. The interval between the said pair of holder frames (41) is less than the interval between the support plates (21), so that a pair of holder frames (41) can be located between the support plates (21).

The said holder frames (41) are positioned at a distance from the wire so as to be able to support the sides of the bread (2), and are connected so as to be able to actuate this wire at the same time. In addition, the said toast holders (40) are furnished on the base (11), move together with the door (31). No holder frame (41) is formed at the top front (the left-side portion of FIG. 1) of the holder frames (41).

The holder frames (41) furnished as a pair are connected to one another by the connecting member (42) at the back. By connecting the back end of the holder frames (41) to the adjacent back of the connecting member (42), the front of the pair of holder frames (41) is made able to spread open or close together.

The elastic member (43) connects to the back of the holder frames (41), and in the absence of external force, the said holder frames (41) spread apart from each other, facilitating the insertion or removal of bread (2) between the holder frames (41).

The toast holders (40) thus furnished are furnished on the base (11) in such a way as to be located between the respective support plates (21). The said connecting member (42) is connected to the base (11), so that if the base (11) moves, the toast holder (40) will move together with the door horizontally so that the bread holder moves outward, thus exposing the bread holder to the exterior, and allowing the bread (2) to be inserted or removed.

A guide (23) is formed so that the front of the said toaster holder (40) then contracts onto the front end of the said support plate (21) in order to enable gripping the bread. In other words, since the holder frames (41) of the said toast holder (40) are designed to spread open under the elastic force stored in the elastic member (43), the front ends of the holder frames (41) must be designed to come together in order to grip the bread (2). To this end, a guide (23) is formed on the front bottom of the said support plates (21), so that the front ends of the said holder frames (41) will come together. The guides (23) furnished on two facing support plates (21) are formed so that the distance across to the facing guide. is reduced going downward As depicted in FIGS. 3 and 4a, if the said holder frames (41) are located within the said guide (23), the toast holder (40) can grip the bread (2) if the said holder frames (41) are brought together.

In order to automatically open and close the said door (31), a door locking means (50) can be furnished.

The door locking means (50) is furnished in order to automatically or manually open and close the said door (31). To this end, as depicted in detail in FIGS. 6a and 6c, the door locking means (50) comprises a push load (51) furnished so as to pass through the said base (11), a solenoid (52) that advances the said push load (51), and a locking block (53) that provides elastic support to the front end of the said door frame (32) and furnished so as to enable sliding, and that is slid by the said push load (51).

The push load (51) is furnished so as to be capable of sliding along the axis of the push load (51), passing through the said base (11).

The solenoid (52) is furnished in order to advance the said push load (51) toward the interior of the toaster (1), and is designed to advance the push load (51) by pushing the push load (51) when electric current flows to the solenoid (52). For example, as depicted in FIG. 6c, the slanted portion (51a) is formed at the outside of the said push load (51), and the front part of the said solenoid (52) is designed to contact the said slanted portion (51a), so that the extension of the said solenoid (52) advances the push load (51).

The locking block is furnished on the front edge of the door frame (32). The locking block is provides elastic support to the said door frame (32), and is supported so as to enable sliding. The locking block (53) is configured so that when it is released from the base (11) by the advancement of the said push load (51), either the door is opened (31), or it is held to the stopping end (11a) that protrudes from the base (11), so that the door (31) cannot open.

In this case, a stopping surface (53a) and slanted surface (53b) are respectively formed on the front edge of the locking block (53). The stopping surface (53a) is intended to prevent the improper opening of the door (31) by catching on the base (11) when the door (31) has been shut. In addition, the slanted surface (53b) is intended to temporarily withdraw the locking block (53) for closure by contacting the said slanted end (53b) to the stopping end of the base (11) when the door (31) is closed.

Together with the said door locking means (50), the door (31) is designed to open and close automatically through the elastic support of the said base (11). In other words, a torsion spring (33) is furnished on the hinge axis which connects the said door (31) to the base (11), and in the absence of outside force, the door (31) is designed to open and the door (31) is designed to optionally open upon operation of the said door locking means (50).

In addition, in order that the toaster (1) can operate only if the said door (31) is closed, it is preferable that a door open/closed sensing means (54) also be furnished which will sense the open/closed status of the door (31). The door open/closed sensing means (54), as depicted in FIGS. 3 and 5, comprises a wedge (54a) formed on the door frame (32) and electroconductive plates (54b) that contact each other upon insertion of the said wedge (54a).

The said wedge is formed on one side of the door frame (32), preferably the bottom edge of the door frame (32), and turns together with the door (31) when it is opened or closed. The said electroconductive plates (54b) contact each other only upon insertion of the said wedge (54a), and are spaced at multiple locations on the base (11) so as to be able to generate a signal.

A bread sensing means is furnished in order to sense whether or not bread has been inserted into the said support plates (21). For example, by furnishing a light-emitting unit (61) and light-receiving unit (52) on the far outside support plates (21), it is sensed whether or not bread has been inserted into the support plates (21) positioned at intervals.

In particular, the said support plates (21) and heating elements (22) are made of a transparent substance that allows the passage of light, and therefore even though the said light-emitting unit (61) and light-receiving unit (62) are installed only on the far outside support plates (21), whether or not bread has been inserted into the support plates (21) can be sensed.

In addition, by furnishing a temperature sensor (63) on the said support plates (21), the temperature of the support plates (21) furnished with heating elements (22) can be detected, so that the passage of temperature beyond the specified level is prevented and an arbitrary temperature can be set.

Accordingly, it is possible for lights (64) to be furnished so as to illuminate the interior of the toaster (1) while bread (2) is being toasted. For example, lights (64) can be furnished on any one or more of the base (11), internal dome (13) or support plate (21), and if electrical current flows through the said heating element (22) at the same time, the surface transparent heating plate Is electrified while the bread (2) is toasting and it can be sensed whether heating is taking place; thus, a visual effect can be obtained.

The unlabeled symbol 71 is an adjusting switch that is used in the operation of the toaster (1).

The toaster of the present invention, having the above-described configuration operates in the following fashion.

First, in order to toast the bread (2), the bread (2) must be inserted into the toaster (1). In order to insert bread (2) into the toaster (1), if the said push-load (51) is depressed, the condition changes from that depicted in FIG. 6a to that depicted in FIG. 6b, and the fastening of the locking block (53) is released from the stopping end (11a) of the base (11), so that the door (31) is opened or closed. The locking block (53) is moved toward the interior of the toaster (1) by the push-load (51), and if the fastening of the stopping edge (53a) of the said locking block (53) is released from the base (11), the door (31) elastically supported by the torsion spring (33) turns and is opened.

As depicted in FIG. 2, if the said door (31) is opened, the toast holder (40) is also exposed to the outside of the toaster (1), together with the door (31). If the toast holder (40) separates from the support plate (210) the toast holder (40) is no longer supported by the guide (23), and therefore the pair of holder frames (41) that comprise the toast holder (40) are spread open by the elastic member (43). Bread (2) is inserted into the space thus opened, and the bread is positioned within the toast holder (40).

In addition, in order to toast the bread (2), the said door (31) is closed and when electric current flows, the bread (2) begins to toast.

When the said door (31) is closed, the door (31) turns and the locking block (53) fastens to the base (11) so as to lock the door (31). If the door (31) closes, the locking block (53) comes into contact with the stopping end (11a) of the base (11) and the locking block (53) is temporarily moved back by the slanted surface (53b) of the said locking block (53), after which the locking block (53) again advances after passing through the stopping end (11a) of the base (11). When the said locking block (53) passes through the stopping end (11a) of the said base (11), the stopping surface (53a) of the locking block (53) comes into contact with the base (11) and the door (31) is not opened but remains closed.

Here, while the said door (31) is closed, the said toast holder (40) contracts, and the condition of the said toast holder (40) changes from that shown in 4b to that shown in 4a so as to grip the bread (2). In the latter part of the process of inserting the toast holder (40) together with the door (31) into the interior of the toaster (1), the respective forward ends of the holder frames (41) come into contact with the guide (23) and contract, while the holder frames (41) come into contact with the side of the bread (2) and the toast holder (40) grips the bread (2).

The bread (2) is inserted into the interior of the toaster (1), and with the door (31) in a closed state, electric power is conducted to the heating elements (22) to toast the bread (2). The said heating elements (22) are surface heating elements, and therefore apply heat evenly to the entire surface of the bread (2). In addition, because the inside and outside of the toaster (1) is blocked off by the said door (31), the heat generated by the heating element (22) is not lost to the exterior.

In addition, because the said housing (12), internal dome (13), support plate (21) and heating element (22) are a transparent material, the process of the bread (2) toasting can easily be observed.

When electricity flows through the said heating element (22), it can be confirmed by the bread sensing means whether bread (2) has been inserted into the support plate (21). In other works, if the bread (2) has been inserted into the support plates (21), the light emitted by the light emission unit (61) will not be sensed by the light receiving unit (62), and if the bread (2) has not been inserted, the light emitted by the light emission unit (61) will be sensed by the light receiving unit (62); thus, by this means the it can be sensed whether bread (2) has been inserted into the support plates (21), so that electric current is conducted to the said heating element (22) only if the bread (2) has been inserted.

In addition to this, the toaster (1) will operate only if the door (31) is sensed to be closed via the door open/closed sensing means (54). By operating the toaster (1) only when the electroconductive plates (54b) that were pushed apart by the pressure of the wedge (54a) of the door open/closed sensing means (54) on the sides of the electroconductive plates (54b) are in contact and conducting electricity, it is made so that toaster (1) cannot be operated when the door (31) is in an opened state.

In addition, by illuminating the surface heating elements (21, 22) via the lights (64) while electricity is being conducted to the said heating elements (22), it is possible to sense whether heat is being generated by the heating elements (21, 22) within the toaster (1).

In addition, because the said housing (12), internal dome (13), support plate (21) and heating element (22) are a transparent material, the light emitted by the lights (64) can easily be recognized from outside.

In addition, the temperature within the toaster (1) is measured using a temperature sensor (63) attached to the said support plates (21), and a temperature exceeding the set temperature is sensed, the supply of electricity to the heating element (22) is shut off, thereby enabling the bread to be toasted at the desired temperature.

If the set temperature or time is reached, or the user's judgment is that the bread (2) within the toaster (1) has been fully toasted, the bread is discharged from the toaster (1).

For example, if the set time or temperature has been reached, the solenoid (52) expands to push the push load (51) (see FIG. 6c), or if the user depressed the push load (51), as described hereinabove, the fastening of the locking block (53) to the stopping end (11a) of the base (11) is released so that the door (31) can be opened.

The crumbs generated in the course of toasting the bread (2) or of inserting or removing bread from the toaster (1), as described above, are collected by the tray (34) underneath via the discharge hole (32a) formed on the door frame (32). The breadcrumbs collected by the tray (34) are removed and disposed of by withdrawing the said tray (34).

While this invention is susceptible to embodiments in many different forms, this specification and the accompanying drawing disclose only preferred forms as examples of the invention. The invention is not intended to be limited to the embodiments so described, however. The scope of the invention is identified in the appended claims.

What is claimed is:

1. A toaster-and-oven device, comprising:
a housing located on top of the base and furnished with an internal dome with a space formed internally;
multiple support plates positioned at intervals in the interior of the said internal dome and actually oriented either vertically or horizontally with respect to the said base, and furnished on the surface with transparent surface heating elements;
a door the bottom edge whereof is hinged to the said housing so that one side of the said internal dome and housing can be opened and closed, and furnished with a door frame that extends into the interior of the said housing; and
toast holders furnished on the said door, and formed so as to contract in a way that enables gripping of the bread between the said support plates when the said door is closed.

2. The device of claim 1, wherein:
on the bottom of the said support plates, a guide is formed that protrudes toward the facing support plate, and
the said toast holder comprises a pair of holder frames that are positioned at a set interval and in contact with the bread surface and that extend from the said door toward the interior; connecting members that hinge the respective holder frames at the back of the said pair of holder frames; and elastic members that provide elastic support that enables the front ends of the said pair of holder frames to spread apart from each other, wherein both ends are connected respectively to the back of the said pair of holder frames; when the said door is closed, the front end of the said holder frame contacts the said guide and the holder frame contracts so as to grip the bread.

3. The device of claim 1, wherein:
the said housing, internal dome and support plates are of a transparent material, and the top can be closed tightly.

4. The device of claim 1, wherein:
the cooking process is transparently visible due to the transparency of the said heating element together with the support plates, internal dome and housing, and specifically wherein the said heating element is a transparent surface heating element, and this heating element is a transparent surface heating element that increases the temperature to 280° C. or above within 1-2 minutes.

5. The device of claim 1, wherein:
on the said base a slanted area is formed on the outside, and a door-locking means is furnished comprising a push-load furnished so as to slide on the said base, a solenoid that advances the said push-load when the slanted portion is pushed, due to the front adjoining the said slanted portion; and a locking block that is in contact with the front of the said push-load and can slide on the said door-frame and that provides elastic support while optionally locking to the said base; and
wherein the said door is connected by springs so as to provide elastic support to the said base, and if the binding of the locking block at the said door locking means is released from the base, the door is opened.

6. The device of claim 1, wherein:
on the said base is also furnished a bread-sensing means that verifies the presence or absence of bread.

7. The device of claim 6, wherein:
the said bread-sensing means is furnished on the base, positioned at the light-emitting unit furnished on the far outside base and the base placed at the far outside of the opposite support plate, and comprises a light-receiving unit that outputs a signal upon receiving light emitted by the said light-emitting unit.

8. The device of claim 1, wherein:
lights are additionally furnished on at least one of the said base, heating plate and internal dome, in order to illuminate the heating plates or housing.

9. The device of claim 1, wherein:
there are also furnished a wedge on the bottom of the said door frame, and door-closure sensing means that senses the closure or opening of the door, and are placed at intervals on the base and that include multiple electroconductive plates that come into contact with the said wedge upon closure of the said door.

10. The device of claim 1, wherein:
a temperature sensor is additionally furnished on the said support plates, and
wherein, when the temperature of the said bread is sensed by the said temperature sensor as exceeding the specified temperature, the heat generation of the said heating plate is cut off.

11. The device of claim 1, wherein:
on the said base is also furnished a tray for the collection of breadcrumbs.
